(19) United States
(12) Patent Application Publication
(10) Pub. No.: US 2024/0386333 A1
(43) Pub. Date: Nov. 21, 2024

(54) METHODS AND SYSTEMS FOR DETERMINING DECISION TREES FOR CATEGORICAL DATA

(71) Applicant: Capital One Services, LLC, McLean, VA (US)

(72) Inventors: Prashanta SAHA, Bangalore (IN); Anupam SHIT, Bankura (IN); Abhishek TEWARI, Allahabad (IN); Gaurav KEDIA, Bangalore (IN); Joydeep DASGUPTA, Bangalore (IN); Arun Kaushik Narmadha RAMESH, Neyveli (IN)

(73) Assignee: Capital One Services, LLC, McLean, VA (US)

(21) Appl. No.: 18/501,918

(22) Filed: Nov. 3, 2023

(30) Foreign Application Priority Data
May 17, 2023 (IN) 202321034598

(51) Int. Cl. G06N 20/20

(52) U.S. Cl. CPC G06N 20/20

(57) ABSTRACT

Systems and methods for generating decision trees are described. In some embodiments, a computer-implemented method to generate a machine learning decision tree may include accessing data to generate the decision tree, the data comprising a plurality of categorical variables; determining an event rate for each of the plurality of categorical variables generating a recursive tree comprising one or more nodes for the plurality of categorical variables via, for each of the one or more nodes: determining a node split for the one or more nodes based on the event rate for each of the plurality of category variables, the node split to split each of the one or more nodes into two nodes, and determine an encoder based on the node split for each level of the recursive tree; and generating the decision tree using a plurality of encoders comprising the encoder for each level of the recursive tree.

### CROSS-REFERENCE TO RELATED APPLICATIONS

This application claims the benefit of priority to Indian Provisional Patent Application No. 20/2321034598, filed May 17, 2023, the entirety of which is incorporated herein by reference.

### TECHNICAL FIELD

The described technology generally relates to computing platforms, and more specifically, to processes for generating decision trees for data that includes categorical data.

### BACKGROUND

Machine learning (ML) models and algorithms may be used to generate a prediction, classification, and/or other type of output based on input data. Decision trees are a prominent type of ML model. In general, a decision tree is a supervised learning method used for classification and regression. A decision tree may be an ML model configured to predict the value of a target variable by learning simple decision rules inferred from data features used to build and/or train the decision tree. As such, decision trees may provide a condition-based model for predicting an outcome, for example, configured as a series of if-then-else statements providing a decision boundary to predict a given outcome.

Although decision trees are widely used for their simplistic approach to decision making, conventional decision tree technologies are ineffective at dealing with certain features, such as categorical variables and/or missing data (or observations). In addition, the process of decision tree development is cumbersome and requires a user to navigate through multiple libraries that each have their own specific requirements and may not work with other libraries. Accordingly, there is a lack of a standard development process, causing users to employ on various ad-hoc approaches that rely on multiple different algorithms, each with non-standardized underlying assumptions that require individualized knowledge and configuration. Accordingly, decision tree development and implementation using conventional technology is an inefficient and resource-intensive process, particularly for categorical data.

### SUMMARY

Embodiments disclosed herein provide systems, methods, articles of manufacture, and computer-readable media for developing machine learning decision trees.

In some embodiments, a computer-implemented method to generate a machine learning decision tree model may include, via at least one processor of a computing device: accessing data to generate the decision tree model, the data including a plurality of categorical variables; determining an event rate for each of the plurality of categorical variables; generating a recursive tree including one or more nodes for the plurality of categorical variables via, for each of the one or more nodes: determining a node split for the one or more nodes based on the event rate for each of the plurality of category variables, the node split to split each of the one or more nodes into two nodes, and determining an encoder based on the node split for each level of the recursive tree; and generating the decision tree using a plurality of encoders comprising the encoder for each level of the recursive tree.

In some embodiments of the computer-implemented method, the method may include grouping the categorical variables based on the event rate.

In various embodiments of the computer-implemented method, the recursive tree may be built to a predetermined maximum depth.

In some embodiments of the computer-implemented method, the maximum depth may be six.

In exemplary embodiments of the computer-implemented method, each level of the decision tree may be based on a specific encoder.

In various embodiments of the computer-implemented method, the encoder may include an encoder value assigned to each of the categories.

In some embodiments of the computer-implemented method, the encoder may include a plurality of sets of ranked categories.

In various embodiments of the computer-implemented method, for each round of building the recursive tree, a set of the plurality of sets of ranked categories may be split and assigned encoding values.

In some embodiments, an apparatus may include at least one processor; and a memory coupled to the at least one processor, the memory comprising instructions that, when executed by the at least one processor, cause the at least one processor to: access data to generate a decision tree model, the data including a plurality of categorical variables, determine an event rate for each of the plurality of categorical variables; generate a recursive tree including one or more nodes for the plurality of categorical variables via, for each of the one or more nodes: determining a node split for the one or more nodes based on the event rate for each of the plurality of category variables, the node split to split each of the one or more nodes into two nodes, and determining an encoder based on the node split for each level of the recursive tree; and generate the decision tree using a plurality of encoders including the encoder for each level of the recursive tree.

In some embodiments of the apparatus, the instructions, when executed by the at least one processor, may cause the at least one processor to group the categorical variables based on the event rate.

In various embodiments of the apparatus, the recursive tree may be built to a predetermined maximum depth.

In some embodiments of the apparatus, the maximum depth may be six.

In various embodiments of the apparatus, each level of the decision tree may be based on a specific encoder.

In exemplary embodiments of the apparatus, the encoder may include an encoder value assigned to each of the categories.

In some embodiments of the apparatus, the encoder may include a plurality of sets of ranked categories.

In various embodiments of the apparatus, for each round of building the recursive tree, a set of the plurality of sets of ranked categories may be split and assigned encoding values.

In some embodiments, a non-transitory computer-readable medium may store instructions configured to cause one or more processors of a computing device to: access data to generate a decision tree model, the data including a plurality of categorical variables; determine an event rate for each of the plurality of categorical variables; generate a recursive tree including one or more nodes for the plurality of categorical variables via, for each of the one or more nodes: determining a node split for the one or more nodes based on the event rate for each of the plurality of category variables, the node split to split each of the one or more nodes into two nodes, and determining an encoder based on the node split for each level of the recursive tree; and generate the decision tree using a plurality of encoders including the encoder for each level of the recursive tree.

In various embodiments of the non-transitory computer-readable medium, the instructions may be configured to cause the one or more processors of the computing device to group the categorical variables based on the event rate.

In exemplary embodiments of the non-transitory computer-readable medium, the recursive tree may be built to a predetermined maximum depth of six.

In some embodiments of the non-transitory computer-readable medium, the encoder may include a plurality of sets of ranked categories.

### BRIEF DESCRIPTION OF THE DRAWINGS

By way of example, a specific embodiment of the disclosed device will now be described, with reference to the accompanying drawings, in which:

FIG. 1 illustrates an exemplary decision tree in accordance with various features of the present disclosure;

FIG. 2 illustrates an example data set in accordance with various features of the present disclosure;

FIG. 3 illustrates an embodiment of a logic flow in accordance with various features of the present disclosure;

FIGS. 4A-4C illustrate an embodiment of a decision tree generation process in accordance with various features of the present disclosure;

FIG. 5 illustrates an example of a decision tree generated using one-hot encoding on the data set of FIG. 2;

FIG. 6 illustrates an embodiment of a computing architecture in accordance with various features of the present disclosure.

### DETAILED DESCRIPTION

The described technology is generally directed to processes for generating, building, developing, or otherwise determining machine learning models in the form of decision trees. Some embodiments provide a decision tree building (or encoding) process to optimize decision tree configuration. The building process may be configured to generate decision trees for data sets that include categorical and numeric values. In various embodiments, the building process may determine and use a rank ordering of categorical values based on a ranking property. In some embodiments, the ranking property may be an event or occurrence rate of the category of categorical data. The ranking property may be used to generate an encoding of the categorical data for building the decision tree.

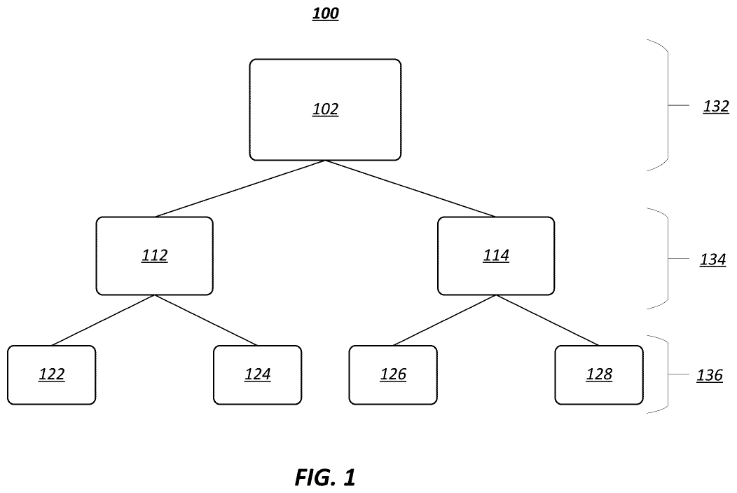

Decision trees provide a condition-based model for predicting an outcome (see, for example, FIG. 1). In general, a decision tree model may be formed as a series of if-then-else statements that provide a decision boundary to predict a given outcome. Even though more complicated and effective modeling methodology exists, decision trees are still widely used for their simplistic and efficient approach to decision making. Typical use cases include using decision trees to find pockets in a dataset where differences in event rates exist, for instance, score carding.

Decision trees may be generated using various systems, platforms, frameworks, programming languages, libraries, packages, and/or the like. Non-limiting examples of programming languages may include the Python and R programming languages. A non-limiting example of a library or package may include the Scikit-learn Python machine learning library. Although Python and Scikit-learn are used as examples, embodiments are not so limited, as the decision tree building processes according to some embodiments may be used with various platforms now known or developed in the future.

Conventional machine learning packages, such as Scikit-learn, may have support for the decision tree classifiers, however they do not provide efficient and effective processes for, among other things, handling categorical variables. Overall, the process of decision tree development is cumbersome and requires the user to navigate through multiple systems, libraries, packages, and/or the like. In addition, decision tree development using standard systems lacks a standard process, instead requiring different algorithms, libraries, packages, and/or the like that require non-standardized underlying assumptions that are often unknown to users.

Like other machine modeling techniques, there are statistical limitations in decision trees that need to be handled before the modeling process may begin. One of the major drawbacks of conventional decision tree modeling techniques, such as Scikit-learn, is the inability to natively handle categorical variables. In general, a categorical variable is a variable that has a category or type for its value. For example, a country-of-residence variable, data quality (DQ) bucket data, age range, or rent/own variable has a category or type as its value. An ordinal variable is similar to a categorical variable, except that the categories or types have an ordering (for instance, a grade category in an order of A-F). A numeric variable is a variable where the measurement or number has a numeric meaning (for instance, an age variable, a salary variable, and/or the like).

Accordingly, in order to generate a decision tree, conventional processes necessitate converting or encoding categorical data into numerical values before the data set can be supplied to a modeling process to generate a decision tree.

Conventional techniques are available to encode categorical variables, such as one-hot encoding, target encoding, and/or the like. For example, conventional encoding techniques may translate categorical variables into numeric format by using dummy variables or replacing categorical variables with numeric identifiers; however, this approach is inefficient and cumbersome. The most commonly used approach is creating dummies, or indicator variables, corresponding to each category of the categorical variable. However, this approach greatly increases the complexity and required resources as the number of categories increases and, therefore, is an inefficient method of dealing with categorical variables.

There are other encoding methods available apart from creating dummies. One widely used technique involves using a target event rate to rank order categories and replacing categories by the numeric ranks. In general, an event rate is a measure of how often a statistical event occurs within a data set or experimental group. The category-wise event rate process needs to be calculated recursively for each node since the population composition changes from node to node. This leads to complexity, inefficiency, and greatly increases resource requirements.

For target encoding, each category is replaced by the mean of the target variable for the respective categories, which may lead to an overfit, particularly for categories with thin data. The overfit issue becomes more pronounced when working with decision tree-based models, for example, as algorithms like one-het encoding can create an unwanted bias by favoring continuous variables for splitting thus making them more “important.” As a result, developers may receive sub-optimal models with a structure based on misinformed variable importance. In addition, weighing the event rate using conventional target encoding processes, and treating the variable as continuous, may lead the model to be over sensitive to rare categories of the variable.

A decision tree makes decisions by splitting nodes into sub-nodes. This process is performed multiple times during the training process until only homogenous nodes are left. This configuration is one of the reasons why a decision tree can perform so efficiently and effectively compared to other machine learning models. Accordingly, node splitting is a key concept for developing effective decision trees.

Accordingly, some embodiments include a decision tree building process that provides an intuitive and accurate decision tree development tool. In some embodiments, the building process may be configured as a library or package for a programming language, such as a Python library that overcomes the challenges of conventional techniques. The decision tree building process may be configured to handle categorical variables intelligently, efficiently, and automatically, while also providing the user with a seamless and efficient end-to-end experience of the model development process.

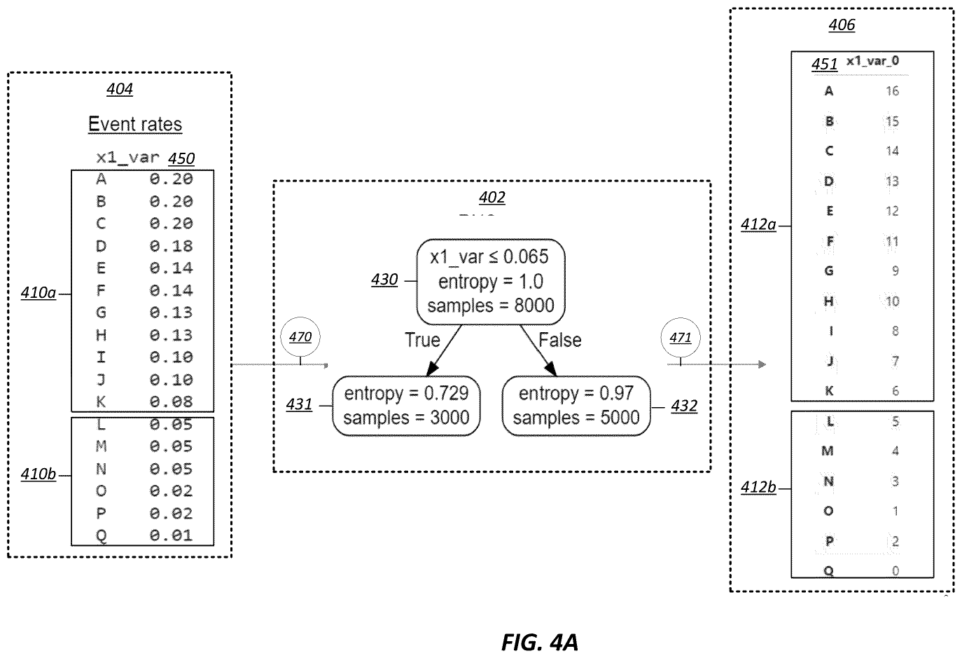

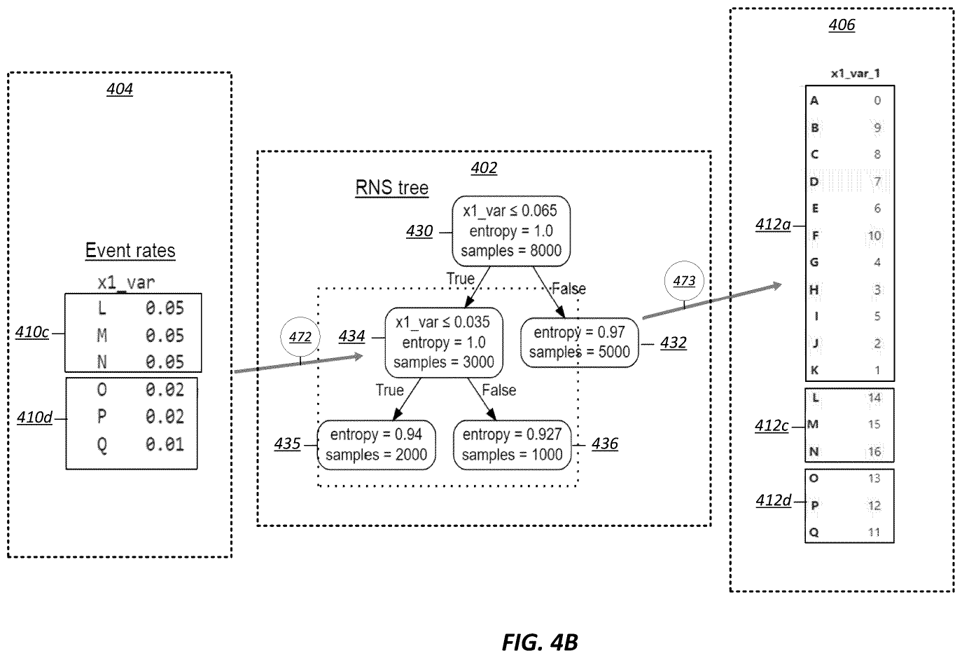

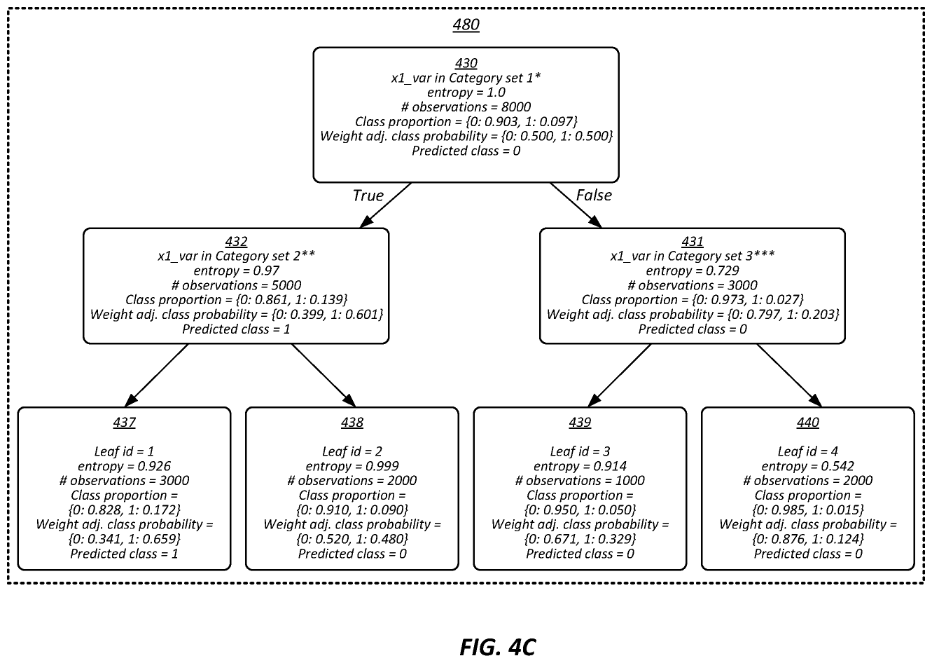

A decision tree building process according to some embodiments may be optimized to manage categorical data. For example, decision tree building processes according to various embodiments may generate a few encoder variables (i.e., less than conventional methods), but each of these encoders are more robust as multiple categories may be combined together in one encoder based on, among other things, the impact of the category to the target variable (see, for example, FIGS. 4A-4C). Accordingly, a decision tree building process according to some embodiments may learn or otherwise determine an unbiased “importance” of categorical variables (which conventional processes are not capable of determining and using to generate decision trees). In addition, in various embodiments, a decision tree building process may operate to encode categorical variables such that categorical variables may be treated the same or similar to continuous variables while evaluating splits, and accounting for variable distribution in the process.

Advantageously, embodiments disclosed herein enable time, processing resources, storage resources and/or other valuable resources to be utilized more efficiently by utilizing the rank ordering (for instance, an event rate) nature of numeric values so that all possible splits are equally likely at any point of split. With such encoding, then at each step the optimal split may be obtained. In this manner, such resources may be better utilized for developing, testing, and training decision trees. Also advantageously, such use of an encoding process according to some embodiments may be scaled up to handle large and/or complex data sets while being efficient and effective.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

FIG. 1 illustrates an exemplary decision tree in accordance with various features of the present disclosure. As shown in FIG. 1, a decision tree (or DT) 100 may include a plurality of nodes 102, 112, 114, 122, 124, 126, 128 arranged in layers (or at a depth) 132 (node 102), 134 (nodes 112 and 114), and 136 (nodes 122, 124, 126, and 128). In general, a decision tree is a non-parametric supervised machine learning method used for classification and regression. Decision trees are configured as a machine learning model that predicts the value of a target variable by learning simple decision rules inferred from the features of a data set used to build and/or train the decision tree.

A decision tree may include a root node (node 102) that is the top-most node of decision tree 100. A parent node (for example, nodes 112 and 114) is a node that gets divided into sub-nodes (for example, nodes 122, 124, 126, and 128) referred to as child nodes. A root node does not have a parent node and may represent the entire population or sample of an associated data set. A leaf or terminal node is a node that does not have any child nodes.

For example, decision tree 100 may be configured to determine a type of living organism based on certain characteristics. Root node 102 may include living organisms (for instance, the answer “yes” to the question “is the subject a living organism?”). Nodes 112 and 114 may split the living organisms into plants and animals (for example, node 112 is the answer “yes” to the question “is the object an animal?” and node 114 may be the answer “yes” to the question “is the object a plant?”).

Continuing further with this example, nodes 122 and 124 may split the “animals” into mammals (for instance, node 122) and all other animals (node 124). Nodes 126 and 128 may split the “plants” into trees (for instance, node 126) and non-tree plants (for instance, node 128). A decision tree may proceed with many nodes and layers of nodes, continually splitting the data until a homogenous node (or “answer”) is obtained. For example, a root node for decision tree 100 may include a particular animal or species of animal (for instance, a “tiger” or “Bengal tiger”) for the “animal” branch or a particular plant or species of plant for the “plant” branch (for instance, a “pine tree” or a “Douglas fir”). In this manner, decision tree 100, once configured/trained on training data, may be used to determine a type of animal or plant based on characteristics of input data of a living organism.

A decision tree building process may be configured to use various types of data sets with various categories, values, and data types (e.g., binary, decimal, hexadecimal, and/or the like). A data set may include independent variables and dependent or target variables. In one non-limiting example, a data set may be associated with a function, such as X1+X2→Y, in which X1 and X2 are independent variables and Y is a target variable. Furthermore, in this example dataset, X1 may be a categorical variable, for instance, that is highly associated with Y, and X2 may be a numeric variable that has little or even no impact on Y. In some examples, X2 may be a random variable. In some examples, Y may be a binary value (i.e., having one of two possible values, such as either a value of 1 or a value of 0).

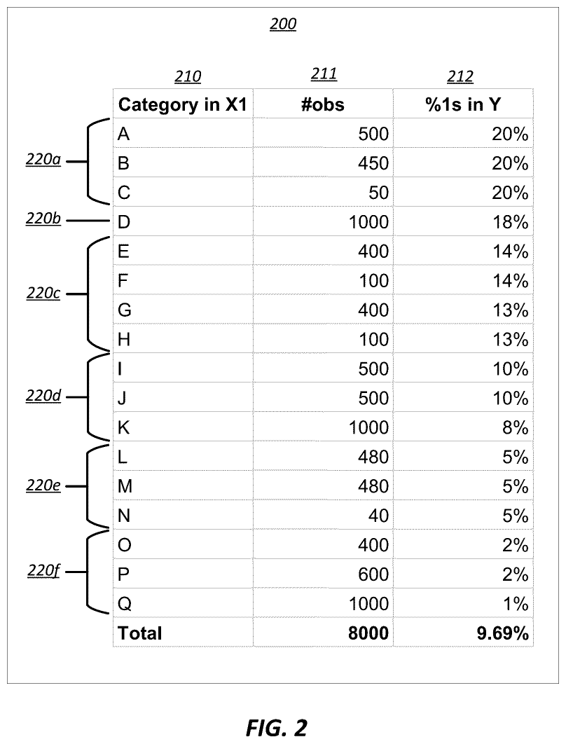

FIG. 2 illustrates an example data set in accordance with various features of the present disclosure. In some embodiments, data set 200 may include values or categories 210f or variable X1. For example, independent variable X1 may include categories A-Q. In various embodiments, data set 200 may include a number of observations 211. In exemplary embodiments, data set 200 may include a percentage of 1s (i.e., % 1s, “hits,” event rate, occurrences, etc.) in Y 212. In some embodiments, % 1s 212 may be an event rate (for instance, an event rate of a category in Y).

The categories A-Q may be divided into groups 220a-f based on an impact factor, for example, related to the impact of the category on the dependent variable Y. For data set 200, the impact factor may be the % 1s 212 factor. Accordingly, categories A-C may be in group 220a, category D may be in group 220b, categories E-H may be in group 220c, categories I-K may be in group 220d, categories L-M may be in group 220e, categories O-Q may be in group 220f. For example, categories may be grouped together if they have a % 1s 212 value that is +/−1% from each other. However, other criteria may be used to group based on a factor. The grouping factor and the grouping criteria (e.g., “cut-offs”) are for illustrative purposes only. Embodiments are not limited in this context.

The data, categories, values, distribution, and groupings in data set 200 are only for non-limiting illustrative purposes, as other data sets with different groupings/configurations may be used with embodiments described in the present disclosure.

Included herein are one or more logic flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation. Blocks designated with dotted lines may be optional blocks of a logic flow.

A logic flow may be implemented in software, firmware, hardware, or any combination thereof. In software and firmware embodiments, a logic flow may be implemented by computer executable instructions stored on a non-transitory computer readable medium or machine readable medium. The embodiments are not limited in this context.

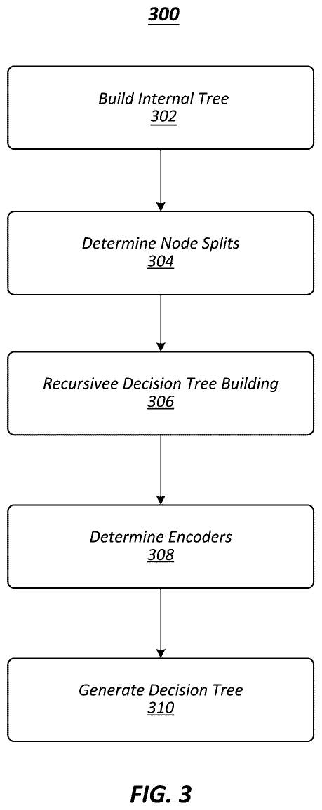

FIG. 3 illustrates an embodiment of a logic flow in accordance with various features of the present disclosure. Logic flow 300 may be representative of some or all of the operations executed by one or more embodiments described herein, such as computing device 600. Logic flow 300 may be representative of some or all of the operations of a decision process building process according to some embodiments. Logic flow 300 is described with reference to data set 200; however, embodiments are not so limited as logic flow 300 may operate with various types of data sets.

Logic flow 300 may build an internal tree at block 302. For example, a tree may be built with a minimum number of levels using all or some of the categories in a data set. In some embodiments, the minimum number of levels may be 2. In various embodiments, the minimum number of levels may be 1, 2, 3, 4, 5, 6, 10, 20, 100, and any value or range between any two of these values (including endpoints). Embodiments are not limited in this context.

The internal tree (or sub-tree) may be used by logic flow 300 in order to, inter alia, restrict the number of encoders needed for a variable. For example, the internal tree may be used to determine the relevant encoders that may be used for the final decision tree building. In some examples, the internal tree may be configured such that there are no more than 64 relevant encoders for a categorical variable. The relevant encoder limit (e.g., 64) may be based on 2^{d}=<encoder limit>, where d=tree depth (or maximum tree depth). Accordingly, for a maximum tree depth of 6, the encoder limit may be 2⁶=64. In various embodiments, for nominal variables, a single encoder may be created based on average event rates.

FIGS. 4A-4C illustrate an embodiment of a decision tree generation process in accordance with various features of the present disclosure. Logic flow 300 may be described in reference to FIGS. 4A-4C (in combination with data set 200). Referring to FIG. 4A, therein is depicted a decision tree 402. In some embodiments, logic flow 300 may generate decision tree 402 as an internal tree at block 302. In various embodiments, logic flow 300 may generate tree 402 as an internal tree with a predetermined depth, such as depth=2. In some embodiments, tree 402 may be built by splitting one node at a time.

At block 304, logic flow 300 may determine node splits. Referring to FIG. 4A, an event rate variable (“x1_var”) 450 or ranking may be generated for data set 200 based, for example, on the % 1s 212 values. The categories may be grouped into groups 410a, 410b based on the event rate variable 450, for instance, to determine two groups of similar categories (based on their event rate). A split 470 may be determined based on the event rates variable 450. For example, tree 402 may be updated based on the first node split, adding nodes 431 and 432 from root node 430.

At block 306, logic flow 300 may recursively build a decision tree. In some embodiments, instead of creating a whole decision tree in a single building event, nodes for a decision tree may be created recursively during a decision tree building process. In various embodiments, the recursive decision tree building process may build a partial tree (a “recursive tree”) (e.g., building upon the internal tree) to a pre-determined recursive depth. In some embodiments, the recursive depth may be 6. In various embodiments, the recursive depth may be 2, 4, 6, 8, 10, 20, 64, 100, 128, 1000, 5000, and any value or range between any two of these values (including endpoints). Embodiments are not limited with respect to the recursive depth unless specified.

At block 308, logic flow 300 may determine encoders. For example, in some embodiments, encoder variables may be determined that give relevant splits in the model, for instance, based on the splits picked up by the recursive tree. Referring to FIG. 4A, an encoder variable (“x1_var_0”) or encloder value 451 may be determined 471. For instance, each category may be assigned an encoder value, such as 0-16 for the 17 different categories A-Q. Each category may be assigned an encoder value. In some embodiments, the encoder value 451 may be based on x1_var event rate variable 450, for instance, as a ranking of the categories based on an event rate. Encoding may generate groupings 412a and 412b.

As shown in FIG. 4A, both G and H have the same event rate and were assigned different values (e.g., 9 and 10, respectively). In some embodiments, the actual assigned values may not matter for the final decision tree process, as both of them will be treated together due to the same event rates. Had there been an ordering in their event rates, the assigned values may operate to also maintained the ordering of the categories.

In some embodiments, splits and/or groupings may be determined based on various functions. Non-limiting examples of functions may include impurity functions, entropy functions, and/or the like (for instance, Entropy and/or Gini functions).

In general, a decision tree model may be generated to combine homogeneous observations into one group, and at each step, the process can split the data into two groups only. In some embodiments, the data may be split into two groups based on reduction of an impurity function (for instance, Entropy, Gini, and/or the like). For instance, referring to FIG. 4A, a decision tree process may identify a split between K and L (group 412a and 412b), as that split that is the most optimal for the impurity (or entropy) function for the given dataset. In various embodiments, this split may be one iteration of the decision tree generation process, with a corresponding encoder (x1_var_0 encoder value 451).

In various embodiments, the decision tree generation process may run a tree for the two splits it has identified in further iterations and group 410b (e.g., L-Q) gets split further (groups 412c and 412d in FIG. 4B). Based on this split (e.g., creating groups 412c and 412d in FIG. 4B), another encoder variable (x1_var_1) may be created. The decision tree generation process iterations may continue until an end event, such as the end of the data (e.g., no more data or groups to split), maximum tree depth, or a threshold of the impurity (or entropy) function, such as a lack of significant lift in the impurity function, for instance, splitting does not improve/increase/decrease the entropy (or impurity) by at least some predetermined (threshold) value (which may be zero, meaning no change).

Referring to FIG. 4B, therein is depicted a subsequent round of determining node splits (block 304), recursive tree building (block 306), and determining encoders (block 308). Group 410b in FIG. 4A, is split into groups 410c and 410d (a second node split) and another level of recursive tree 402 is built 472, adding nodes 434-436. Based on the second node split depicted in FIG. 4B, a second encoder (“x1_var_1”) 451 may be determined 473.

At block 310, logic flow 300 may generate a decision tree. For example, the steps of determining node splits (at block 304), recursive tree building (block 306), and determining encoders (block 308) may be repeated to encode all of the data of data set 200 to generate a decision tree. FIG. 4C depicts a decision tree 480 with nodes 430-432 and 437-440. Decision tree 480 represents the full decision tree for data set 200 using a decision tree building process according to some embodiments. The first level of node 430 is based on a first encoder (e.g., x1_var_0; see, for example, FIG. 4A); the second level of nodes 431 and 432 are based on the second encoder (e.g., x1_var_1; see, for example, FIG. 4A). A total number of encoders generated during the process to build decision tree 480 was 16. Category set 1 included categories A-K; category set 2 included categories A-H; and category set 3 included categories L-N.

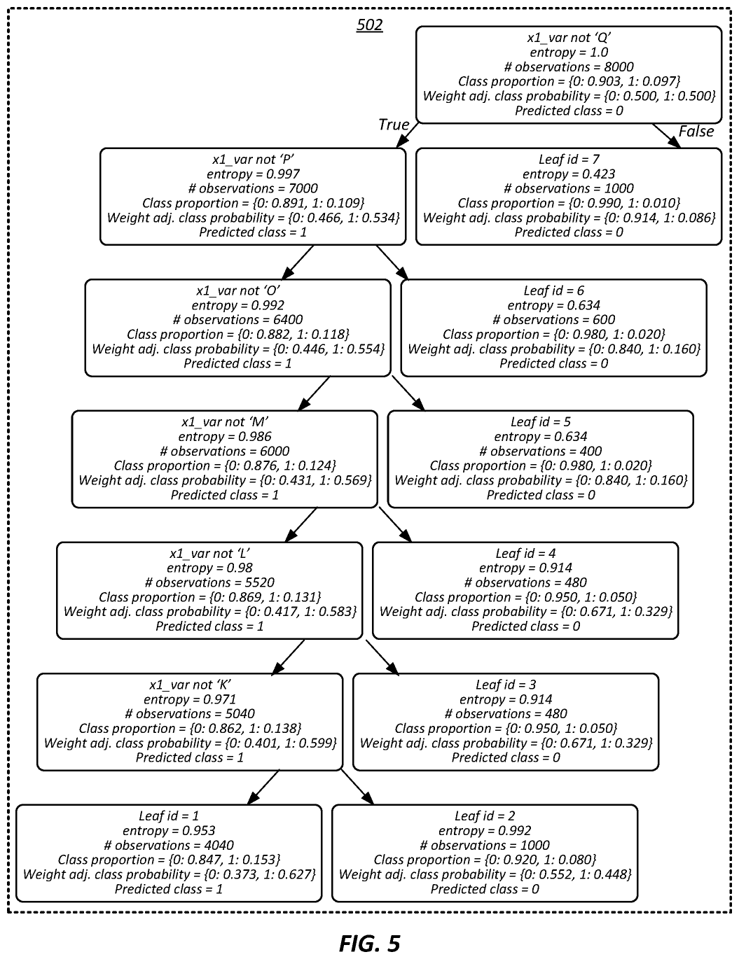

FIG. 5 illustrates an example of a decision tree generated using one-hot encoding on the data set of FIG. 2. As shown in FIG. 5, a decision tree 502 generated using conventional processes, such as one-hot encoding, for data set 200 generates a decision tree model that is more complicated and includes more levels (e.g., seven levels versus only three levels for decision tree 480 generated via a decision tree building process according to some embodiments). In addition, the total number of encoders required to generate decision tree 502 was 12, 938. Accordingly, decision tree building processes according to various embodiments are more efficient, use less resources, and generate simpler and less complex decision trees.

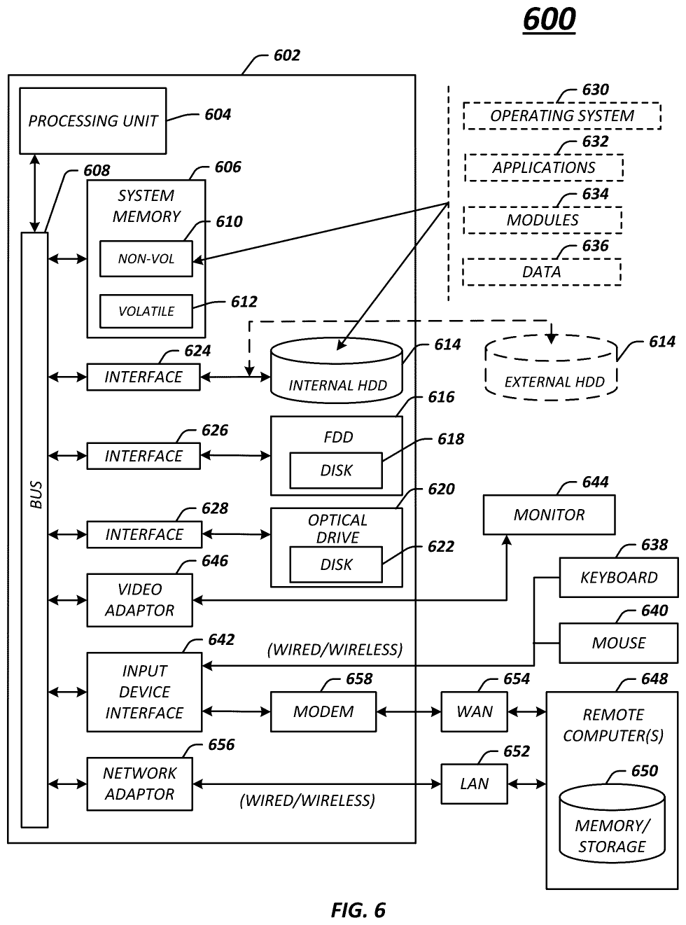

FIG. 6 illustrates an embodiment of an exemplary computing architecture 600 comprising a computing system 602 that may be suitable for implementing various embodiments as previously described. In various embodiments, the computing architecture 600 may comprise or be implemented as part of an electronic device. In some embodiments, the computing architecture 600 may be representative, for example, of a system that implements one or more components of processes or logic flow 300. More generally, the computing architecture 600 may be configured to implement the logic, applications, systems, methods, GUIs, apparatuses, and functionality described herein with reference to the preceding figures.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 602 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 602.

More specifically, the computing system 602 comprises a processor 604, a system memory 606 and a system bus 608. The processor 604 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi processor architectures may also be employed as the processor 604.

The system bus 608 provides an interface for system components including, but not limited to, the system memory 606 to the processor 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computing system 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies. The computing system 602 is generally configured to implement all logic, systems, methods, apparatuses, and functionality described herein with reference to the preceding figures.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components disclosed herein, e.g., the logic flow 300.

A user can enter commands and information into the computing system 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computing system 602. In addition to the monitor 644, a computer typically includes other peripheral output devices, such as speakers, printers, and so forth.

The computing system 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computing system 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet. In various embodiments, the network 109 may be one or more of the LAN 652 and the WAN 654.

When used in a LAN networking environment, the computing system 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computing system 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computing system 602, or portions thereof, can be stored in the remote memory/storage device 650. It will be appreciated that the network connections shown are exemplary and other means of establishing a communications link between the computers can be used.

The computing system 602 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A computer-implemented method to generate a machine learning decision tree model, comprising, via at least one processor of a computing device:
accessing data to generate the machine learning decision tree model, the data comprising a plurality of categorical variables;
determining an event rate for each of the plurality of categorical variables;
generating a recursive tree comprising one or more nodes for the plurality of categorical variables via, for each of the one or more nodes:
determining a node split for the one or more nodes based on the event rate for each of a plurality of category variables, the node split to split each of the one or more nodes into two nodes, and
determining an encoder based on the node split for each level of the recursive tree; and
generating the decision tree using a plurality of encoders comprising the encoder for each level of the recursive tree.

2. The computer-implemented method of claim 1, further comprising grouping the categorical variables based on the event rate.

3. The computer-implemented method of claim 1, wherein the recursive tree is built to a predetermined maximum depth.

4. The computer-implemented method of claim 3, wherein the predetermined maximum depth is six.

5. The computer-implemented method of claim 1, wherein each level of the decision tree is based on a specific encoder.

6. The computer-implemented method of claim 1, wherein the encoder comprises an encoder value assigned to each of the categories.

7. The computer-implemented method of claim 1, wherein the encoder comprises a plurality of sets of ranked categories.

8. The computer-implemented method of claim 7, wherein for each round of building the recursive tree, a set of the plurality of sets of ranked categories is split and assigned encoding values.

9. An apparatus comprising:
at least one processor; and
a memory coupled to the at least one processor, the memory comprising instructions that, when executed by the at least one processor, cause the at least one processor to:
access data to generate a decision tree model, the data comprising a plurality of categorical variables,
determine an event rate for each of the plurality of categorical variables;
generate a recursive tree comprising one or more nodes for the plurality of categorical variables via, for each of the one or more nodes:
determining a node split for the one or more nodes based on the event rate for each of a plurality of category variables, the node split to split each of the one or more nodes into two nodes, and
determining an encoder based on the node split for each level of the recursive tree; and
generate the decision tree using a plurality of encoders comprising the encoder for each level of the recursive tree.

10. The apparatus of claim 9, wherein the instructions, when executed by the at least one processor, cause the at least one processor to group the categorical variables based on the event rate.

11. The apparatus of claim 9, wherein the recursive tree is built to a predetermined maximum depth.

12. The apparatus of claim 11, wherein the maximum predetermined depth is six.

13. The apparatus of claim 9, wherein each level of the decision tree is based on a specific encoder.

14. The apparatus of claim 9, wherein the encoder comprises an encoder value assigned to each of the categories.

15. The apparatus of claim 9, wherein the encoder comprises a plurality of sets of ranked categories.

16. The apparatus of claim 15, wherein for each round of building the recursive tree, a set of the plurality of sets of ranked categories is split and assigned encoding values.

17. A non-transitory computer-readable medium storing instructions configured to cause one or more processors of a computing device to:
access data to generate a decision tree model, the data comprising a plurality of categorical variables;
determine an event rate for each of the plurality of categorical variables;
generate a recursive tree comprising one or more nodes for the plurality of categorical variables via, for each of the one or more nodes:
determining a node split for the one or more nodes based on the event rate for each of a plurality of category variables, the node split to split each of the one or more nodes into two nodes, and
determining an encoder based on the node split for each level of the recursive tree; and
generate the decision tree using a plurality of encoders comprising the encoder for each level of the recursive tree.

18. The non-transitory computer-readable medium of claim 17, wherein the instructions are configured to cause the one or more processors of the computing device to group the categorical variables based on the event rate.

19. The non-transitory computer-readable medium of claim 17, wherein the recursive tree is built to a predetermined maximum depth of six.

20. The non-transitory computer-readable medium of claim 17, wherein the encoder comprises a plurality of sets of ranked categories.
